(19) United States
(12) Patent Application Publication
(10) Pub. No.: US 2020/0143967 A1
(43) Pub. Date: May 7, 2020

(54) DUST CORE AND METHOD OF MANUFACTURING THE SAME

(71) Applicant: PANASONIC CORPORATION, Osaka (JP)

(72) Inventors: Masato MAEDE, Kyoto (JP); Masaaki TANABE, Hyogo (JP); Taishi FUJIMOTO, Osaka (JP)

(21) Appl. No.: 16/670,835

(22) Filed: Oct. 31, 2019

(30) Foreign Application Priority Data
Nov. 1, 2018 (JP) 2018-206488
Dec. 10, 2018 (JP) 2018-230929
Aug. 22, 2019 (JP) 2019-152009
Aug. 27, 2019 (JP) 2019-154657
Aug. 29, 2019 (JP) 2019-156750

(51) Int. Cl. H01F 1/20; H01F 41/02; B22F 1/00; B22F 1/02

(52) U.S. Cl. CPC H01F 1/20; H01F 41/0246; B22F 1/0011; C22C 38/16; B22F 1/02; B22F 2304/10; B22F 2301/35; B22F 1/0055

(57) ABSTRACT

A dust core achieving both a high magnetic permeability and a high voltage resistance and a method of manufacturing the same are provided. The dust core is a dust core containing a powder of a soft magnetic composition. The powder of the soft magnetic composition includes at least an ellipsoidal powder having a flatness within a range from 3.0 to 6.0.

### CROSS REFERENCE TO RELATED APPLICATIONS

This application is entitled to and claims the benefit of Japanese Patent Application No. 2018-206488, filed on Nov. 1, 2018, Japanese Patent Application No. 2018-230929, filed on Dec. 10, 2018, Japanese Patent Application No. 2019-152009, filed on Aug. 22, 2019, Japanese Patent Application No. 2019-156750, filed on Aug. 29, 2019, and Japanese Patent Application No. 2019-154657, filed on Aug. 27, 2019, the disclosure of which including the specification, drawings and abstract is incorporated herein by reference in its entirety.

### TECHNICAL FIELD

The present disclosure relates to a dust core and a method of manufacturing the same.

### BACKGROUND ART

In recent years, electrified motor vehicles have rapidly been popularized. Examples of the electrified motor vehicle include a hybrid electric vehicle (HEV), a plug-in hybrid electric vehicle (PHEV), and an electric vehicle (EV). In such an electrified motor vehicle, various electronic components and systems are required to reduce the size and weight in order to further improve the fuel economy (electric power consumption).

Furthermore, in association with a market expansion of the electrified motor vehicle, there arises a demand for higher performances for a soft magnetic powder used in a choke coil, a reactor, a transformer, and the like, and for a dust core made of the soft magnetic powder.

A high magnetic permeability is required for the dust core made of the soft magnetic powder, and for this reason, highly dense filling of the soft magnetic powder is necessary. In addition, in order to reduce the size and weight of the dust core made of a powder of the soft magnetic composition, a high saturation magnetic flux density, a small core loss, and excellent direct current superimposition characteristics are required.

For example, Patent Literature 1 discloses a method for highly dense filling of a soft magnetic powder by mixing a crushed powder having a thin plate shape with a spherical powder obtained by an atomization method.

FIG. 12A and FIG. 12B illustrate crushed powders of a Fe-based amorphous alloy ribbon disclosed in Patent Literature 1. The crushed powder is a powder obtained by crushing a ribbon. Crushed powder is also referred to herein as “powder” or “particle”.

FIG. 12A illustrates crushed powder 1 having particle diameters equal to or larger than 50 μm. FIG. 12B illustrates crushed powder 2 having particle diameters equal to or smaller than 50 μm.

The dust core of Patent Literature 1 mainly contains a crushed powder of Fe-based amorphous alloy ribbon (hereinafter simply referred to as “ribbon”) and a Fe-based amorphous alloy atomized spherical powder (hereinafter simply referred to as “atomized spherical powder”).

The particle diameter of crushed powder 1 illustrated in FIG. 12A falls within the range from two times (a thickness of 25 μm×2=50 μm) to six times (a thickness of 25×6=150 μm) the thickness of the ribbon. Further, crushed powder 1 is equal to or larger than 80 mass % of the whole crushed powder.

The particle diameters of the crushed powder 2 illustrated in FIG. 12B are equal to or smaller than two times (a thickness of 25 μm×2=50 μm) the thickness of the ribbon. Further, crushed powder 2 is equal to or smaller than 20 mass % of the whole crushed powder.

It should be noted that, in Patent Literature 1, the particle diameters of crushed powders 1 and 2 are defined to be the minimum values in a plane direction of a main surface of the powder crushed into a thin plate shape.

The particle diameter of the atomized spherical powder falls within the range from 3 μm to ½ the thickness of the ribbon (a thickness of 25 μm×½=12.5 μm).

### CITATION LIST

### Patent Literature

### PTL 1

### Japanese Patent No. 4944971

### SUMMARY OF INVENTION

### Technical Problem

For highly dense filling of the soft magnetic powder constituting the dust core, it is necessary to press mold the powder core at a high pressure during the production of the dust core. However, since particles of the soft magnetic powder contact each other and insulation among the powder particles cannot be maintained, the voltage-resistant performance is deteriorated.

In particular, when a thin plate-shaped powder having sharp edges as disclosed in Patent Literature 1 is pressurized, sharp edges of the powder particles bite into adjacent powder particles, so that the powder particles are in electrical continuity with each other. Accordingly, the voltage-resistant performance is remarkably deteriorated, which makes highly dense filling difficult.

Furthermore, in Patent Literature 1, in the whole crushed powders, crushed powder 1 having a thickness equal to or larger than 50 μm occupies equal to or larger than 80 mass % of the whole crushed powder, and an internal resistance of crushed powder 1 is small. For this reason, electric charges are concentrated to crushed powder 1 having a thickness equal to or larger than 50 μm during the application of voltage, and thus the voltage-resistant performance is deteriorated. Accordingly, highly dense filling becomes difficult.

Further, since the powder having a thin plate shape is oriented in a flow direction during press molding, when combined with a spherical powder as disclosed in Patent Literature 1, gaps among particles of the spherical powder are hardly filled, so that a high packing density is not always obtained.

That is, in the method of Patent Literature 1, it was impossible to obtain the dust core having both of the high magnetic permeability and the high voltage resistance.

It is an object of one aspect of the present disclosure to provide a dust core capable of achieving both a high magnetic permeability and a high voltage resistance and a method of manufacturing such a dust core.

### Solution to Problem

A dust core according to one aspect of the present disclosure is a dust core including a powder of a soft magnetic composition, wherein the powder of the soft magnetic composition contains an ellipsoidal powder having at least a flatness within a range from 3.0 to 6.0 both inclusive.

A method of manufacturing a dust core, according to one aspect of the present disclosure is a method including: producing at least an ellipsoidal powder by causing particles of soft magnetic composition to rub up against each other; mixing the ellipsoidal powder with a binder to produce a granulated powder; filling a predetermined mold with the granulated powder and performing press-molding to obtain a green compact; and heating the green compact at a temperature at which the binder is cured, in which the flatness of the ellipsoidal powder falls within a range from 3.0 to 6.0 both inclusive.

### Advantageous Effects of Invention

According to the present disclosure, a dust core achieving both the high magnetic permeability and the high voltage resistance is provided.

### BRIEF DESCRIPTION OF DRAWINGS

FIG. 1A schematically illustrates a process of manufacturing a soft magnetic powder according to Embodiments 1 to 3 of the present disclosure;

FIG. 1B schematically illustrates a process of manufacturing a soft magnetic powder according to Embodiments 1 to 3 of the present disclosure;

FIG. 1C schematically illustrates a process of manufacturing the soft magnetic powder according to Embodiments 1 to 3 of the present disclosure;

FIG. 2 schematically illustrates an example of a configuration of a cyclone mill according to Embodiments 1 to 3 of the present disclosure;

FIG. 3 illustrates an SEM image of a soft magnetic powder according to Example 1 of the present disclosure;

FIG. 4 illustrates a particle size distribution of the soft magnetic powder according to Example 1 of the present disclosure;

FIG. 5 illustrates an SEM image of a cross section of a dust core according to Example 1 of the present disclosure;

FIG. 6 illustrates an SEM image of a soft magnetic powder according to Example 2 of the present disclosure;

FIG. 7 illustrates a particle size distribution of the soft magnetic powder according to Example 2 of the present disclosure;

FIG. 8 illustrates an SEM image of a cross section of a dust core according to Example 2 of the present disclosure;

FIG. 9 illustrates an SEM image of a soft magnetic powder according to Example 3 of the present disclosure;

FIG. 10 illustrates a particle size distribution of the soft magnetic powder according to Example 3 of the present disclosure;

FIG. 11 illustrates an SEM image of a cross section of a dust core according to Example 3 of the present disclosure;

FIG. 12A illustrates a crushed powder (having particle diameters equal to or larger than 50 μm) of the Fe-based amorphous alloy ribbon disclosed in Patent Literature 1; and

FIG. 12B illustrates the crushed powder (having particle diameters equal to or smaller than 50 μm) of the Fe-based amorphous alloy ribbon disclosed in Patent Literature 1.

### DESCRIPTION OF EMBODIMENTS

Embodiments of the present disclosure will now be described with reference to the accompanying drawings. It should be noted that the same reference numerals are given to common components in the respective drawings, and description thereof will be omitted as appropriate.

### Embodiment 1

Embodiment 1 of the present disclosure will be described below.

<Method of Manufacturing Soft Magnetic Powder>

A method of manufacturing a soft magnetic powder according to Embodiment 1 will be described. The soft magnetic powder is a powder of a soft magnetic composition.

First, an alloy composition is melted by high-frequency heating or the like and then is cooled by a liquid quenching method to produce ribbons or flakes of an amorphous layer (Step 1).

When performing the liquid quenching method, for example, a single-roll amorphous manufacturing apparatus or a twin-roll amorphous manufacturing apparatus used for manufacturing Fe-based amorphous ribbons may be used.

Although a case where the ribbon(s) of an amorphous layer (hereinafter simply referred to as “ribbon(s)”) are produced will be described below as an example, it is needless to say that the following description will apply to a case where flakes are produced.

Next, the ribbons obtained in Step 1 are crushed to obtain a crushed powder (Step 2).

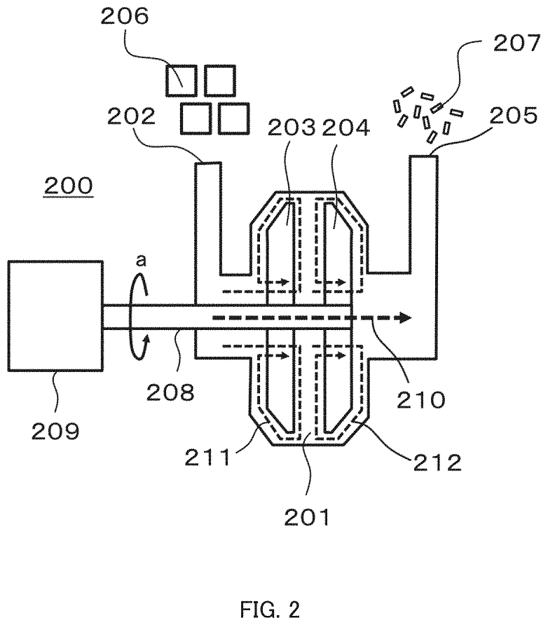

As a method of crushing the ribbons, for example, a method of causing the ribbons to rub up against each other by using a cyclone mill is exemplified. Details of this method will be described later with reference to FIG. 2.

In general, it is known that when the ribbons are heated and crystallized before crushing, the ribbons become brittle and are easy to be crushed. On the other hand, when heated, the ribbons are increased in hardness and thus become difficult to be crushed. Accordingly, the proportion of the crushed powder having a small particle diameter to the whole crushed powder is reduced.

Therefore, in Embodiment 1, a method of crushing the ribbons without being heated is employed in Step 2. Accordingly, the hardness of the ribbons is reduced, and thus the ribbons can be crushed finely. Consequently, the proportion of the crushed powder having a small particle diameter can be increased in the whole crushed powder.

It should be noted that the crushed powder obtained in Step 2 may be classified using, for example, a sieve or the like to obtain a crushed powder having a desired particle size distribution.

In this specification, “crushed powder” is also referred to as “powder”, “powder particles” or “particles”.

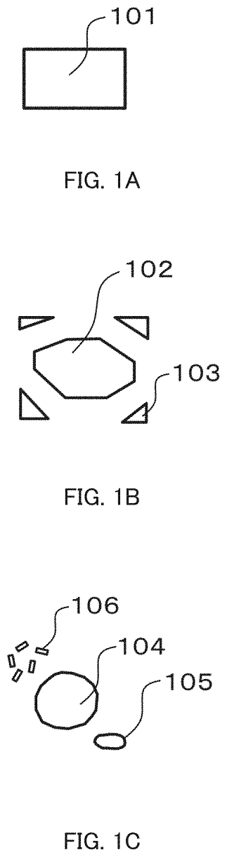

A manufacturing mechanism of the crushed powder in the Step 2 will now be described with reference to FIG. 1A to FIG. 1C.

Examples of soft magnetic ribbon 101 (an example of the soft magnetic composition) illustrated in FIG. 1A include a metal, an alloy, a silicon steel sheet, an amorphous alloy, or a nanocrystalline alloy, which have a soft magnetic property.

When the cyclone mill is used, soft magnetic ribbons 101 such as the one illustrated in FIG. 1A are entrained in the airflow and rub up against each other. Accordingly, surfaces of soft magnetic ribbons 101 are scraped off, and powder 102 and powder 103 as illustrated in FIG. 1B are produced.

Further, by continuing the crushing, powder 102 and powder 103 are also entrained in the airflow, and particles of the powder 102 and 103 rub up against each other. Accordingly, surfaces of particles of powder 102 are scraped off, and powder 104 of spherical particles and powder 106 of scaly particles as illustrated in FIG. 1C are produced. Moreover, the surfaces of particles of powder 103 are scraped off and powder 105 of ellipsoidal particles and powder 106 of scaly particles are produced as illustrated in FIG. 1C. Powder 106 is shavings scraped from powder 102 or powder 103.

The manufacturing mechanism of the crushed powder has been described above. Hereinafter, Step 3 after Step 2 will be described.

The crushed powder obtained in Step 2 is heat-treated to remove internal strain caused by crushing or to precipitate an αFe crystal layer (Step 3).

As the heat treatment apparatus, for example, a hot air oven, a hot press, a lamp, a sheathed heater, a ceramic heater, a rotary kiln, or the like can be used.

By the Step 1 to 3 described above, a crushed powder made from amorphous layer ribbons, that is, a soft magnetic powder can be produced.

<Method of Manufacturing Dust Core>

A method of manufacturing the dust core according to the embodiments of this disclosure will be described.

First, the soft magnetic powder produced in Step 1 to 3 is mixed with a binder to prepare granulated powder (Step 4).

Examples of the binder include a resin having good insulation properties and high heat-resistance (for example, a phenol resin or a silicone resin).

Next, a mold having a high heat-resistance and having a desired shape is filled with the granulated powder obtained in Step 4, and is subjected to press molding to obtain a green compact (Step 5).

Next, the green compact obtained in Step 5 is heated at a temperature at which the binder is cured (Step 6).

By the Step 4 to 6 described above, a dust core having a high magnetic permeability can be produced.

### Example 1

Example 1 will be described below. In Example 1, the method of manufacturing the soft magnetic powder and the method of manufacturing the dust core according to Embodiment 1 described above are specifically embodied.

In Example 1, a Fe-based amorphous alloy ribbon of Fe73.5-Cu1-Nb3-Si13.5-B9 (numerical values subsequent to atomic symbols represent atomic %) produced by a rapid-cooling single-roll method was crushed by using a cyclone mill to obtain a soft magnetic alloy powder of an amorphous layer.

<Crushing Mechanism by Cyclone Mill>

The crushing mechanism by the cyclone mill will be described with reference to FIG. 2. FIG. 2 schematically illustrates an example of a configuration of cyclone mill 200 used in Example 1.

Cyclone mill 200 includes crushing chamber 201, raw material inlet port 202, rotary blades 203 and 204, outlet port 205, rotary shaft 208, and drive source 209.

Raw material inlet port 202 is an opening through which raw material 206 is charged, and communicates with crushing chamber 201. Raw material 206 is, for example, soft magnetic ribbons 101 illustrated in FIG. 1A.

Outlet port 205 is in communication with crushing chamber 201, and is an opening through which raw material particles 207 generated in crushing chamber 201 are discharged. A suction apparatus (not illustrated) is provided outside outlet port 205.

Crushing chamber 201 is a space in which raw material 206 is crushed.

Crushing chamber 201 is provided with rotary blades 203 and 204. Rotary blades 203 and 204 are fixed to rotary shaft 208, respectively. Rotary shaft 208 is rotated by drive source 209 (for example, a motor), as indicated by arrow a. Accordingly, rotary blades 203 and 204 are rotated in the same manner.

As rotary blades 203 and 204 are rotated, airflow 210 and circulating flows 211 and 212 are constantly generated.

Airflow 210 is an airflow flowing from an inlet side of crushing chamber 201 through crushing chamber 201 to an outlet side of crushing chamber 201.

Circulating flow 211 is an airflow that circulates along a surface of rotary blade 203.

Circulating flow 212 is an airflow that circulates along a surface of rotary blade 204.

A flow of charging raw material 206 to cyclone mill 200 having such a configuration as described above to obtain raw material particles 207 will be described below.

Raw material 206 charged from raw material inlet port 202 is entrained in airflow 210 and flows into crushing chamber 201.

On the other hand, raw material 206 that has flowed into crushing chamber 201 is entrained in circulating flow 211 or circulating flow 212 and moves in crushing chamber 201. At this time, raw material 206 entrained in circulating flow 211 and raw material 206 entrained in circulating flow 212 rub up against each other and thus are crushed. By the friction crushing, raw material particles 207 are produced. Raw material particles 207 generated here are, for example, powders 104, 105 and 106 illustrated in FIG. 1C.

Fine powder (for example, powder 106 illustrated in FIG. 1C) in raw material particles 207 is entrained in airflow 210, flows out from crushing chamber 201, and is recovered from outlet port 205 by the suction force of the suction apparatus (not illustrated).

In Example 1, an execution time of the crushing was set to 50 minutes. That is, raw material 206 (soft magnetic ribbons 101) was charged from the raw material inlet port 202 while rotating rotary blades 203 and 204 for 50 minutes. Accordingly, raw material 206 entrained in circulating flow 211 and raw material 206 entrained in circulating flow 212 rub up against each other, so that the surfaces of the particles of respective raw materials 206 were scraped off, and accordingly, powders 104, 105 and 106 illustrated in FIG. 1C were produced as final raw material particles 207.

Powder 106, which is a fine powder, converges toward the axis (center portion of rotary blades 203 and 204) of rotary shaft 208, is entrained in airflow 210, flows out of crushing chamber 201, and is discharged from outlet port 205 by a suction force of the suction apparatus. In this manner, only powder 106 having a certain particle size could be continuously recovered. The recovered powder 106 was scaly.

In contrast, powders 104 and 105, which are particles larger than powder 106, are entrained in circulating flow 211 or circulating flow 212, and are retained in crushing chamber 201 with the surfaces being scraped off. In other words, powder 106 is also produced from powders 104 and 105 during the retention. Powder 106 was also recovered from outlet port 205 as described above.

When the crushing was completed (after 50 minutes have elapsed), a rounded spherical powder 104 and a rounded ellipsoidal powder 105 were left in crushing chamber 201.

In Example 1, the execution time of crushing is set to 50 minutes, but it can be adjusted as appropriate according to the desired shape and particle diameter. Further, in Example 1, a case of producing powders 104 to 106 by using cyclone mill 200 has been described as an example, but powders 104 to 106 may be produced by other apparatuses or other methods.

In Example 1, a cyclone mill 150S, which is of a single-motor type manufactured by Shizuoka Plant Co., Ltd., was used as cyclone mill 200. The rotational speed is preferably 11,000 to 15,000 rpm, and the optimum value is 15,000 rpm. Therefore, in Example 1, a rotational speed of 15,000 rpm is used.

In the case of using a planetary ball mill, an attritor, a sample mill, or a vibration mill, the spherical powder or the ellipsoidal powder cannot be produced (that is, the particles cannot be rounded), and the average particle diameter of the powder exceeds 20 μm. When a mixer mill is used, the average particle diameter of the powder is 10's μm, but the spherical powder or the ellipsoidal powder cannot be produced (that is, the particles cannot be rounded). In addition, the crushing cannot be achieved by the jet mill.

Powders 104, 105 and 106 obtained in a manner as described above were subjected to the following processes.

First, powders 104, 105 and 106 were heat-treated to remove internal strain caused by crushing, and αFe crystal layer was precipitated. The heat treatment was performed by heating powders 104, 105 and 106 at 560° C. for 2 seconds by using a hot press.

Powders 104, 105, and 106 are mixed so as to satisfy the relation of powder 104+powder 105:powder 106=90 wt %:10 wt % to produce a mixed powder.

Next, the mixed powder and a silicone resin as a binder were mixed together to produce a granulated powder. The amount of the silicone resin in the mixed powder was about 3 wt %.

Next, the granulated powder was charged into a mold, and press-molded by using a press machine at a molding pressure of 4 ton/cm² to produce a green compact.

<Evaluation of Initial Magnetic Permeability>

The initial magnetic permeability at a frequency of 100 kHz was measured with respect to the green compact obtained as described above by using an impedance analyzer. Here, the acceptance and rejection criteria of the initial magnetic permeability was set to 19 at the maximum. The reason for this is that the target initial magnetic permeability is equal to or higher than the initial magnetic permeability of the general metal-based materials whose loss is almost the same. The initial magnetic permeability was 21 as a result of the measurement by the impedance analyzer. Therefore, the obtained green compact has passed the acceptance criteria, and had a high magnetic permeability.

<Shape of Soft Magnetic Powder>

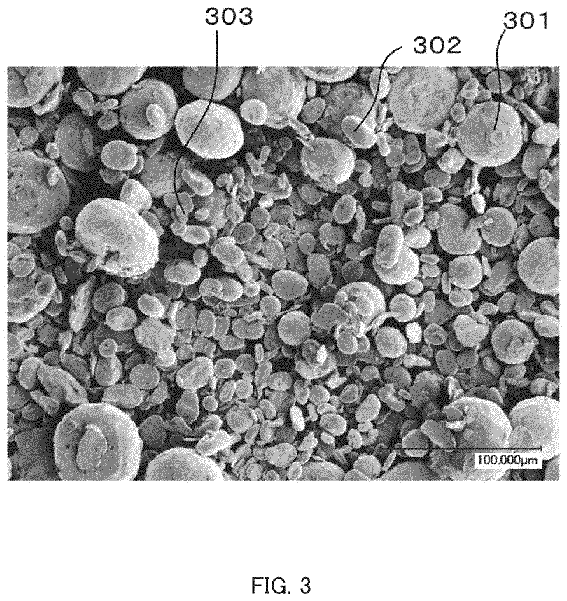

The shape of the soft magnetic powder obtained in Example 1 will be described with reference to FIG. 3. FIG. 3 illustrates an SEM (Scanning Electron Microscope) image of the soft magnetic powder according to Example 1.

In FIG. 3, first powder 301 corresponds to powder 104 illustrated in FIG. 1C, second powder 302 corresponds to powder 105 illustrated in FIG. 1C, and third powder 303 corresponds to powder 106 illustrated in FIG. 1C.

As illustrated in FIG. 3, first powder 301 is a spherical powder, second powder 302 is an ellipsoidal powder, and third powder 303 is a scaly powder.

<Particle Size Distribution of Soft Magnetic Powder>

The particle diameter of first powder 301 was larger than 32 μm. First powder 301 was 36 wt % of the whole crushed powder.

The particle diameter of second powder 302 was equal to or smaller than 32 μm. The amount of second powder 302 was 54 wt % of the whole crushed powder.

The particle diameter of third powder 303 was equal to or smaller than 32 μm. The amount of third powder 303 was 10 wt % of the whole crushed powder.

It should be noted that the particle diameter was determined by whether or not each of first powder 301, second powder 302, and third powder 303 could pass through an opening having a diameter of 32 μm.

The summary of the characteristics of first powder 301, second powder 302, and third powder 303 is shown in Table 1.

TABLE 1

| | shape | particle diameter | wt % |
|---|---|---|---|
| first powder 301 | spherical | larger than 32 μm | 36 wt % |
| second powder 302 | ellipsoidal | equal to or smaller | 54 wt % |
| | | than 32 μm | |
| third powder 303 | scaly | equal to or smaller | 10 wt % |
| | | than 32 μm | |

In order to increase the packing density of the soft magnetic powder, in Example 1, first powder 301, second powder 302, and third powder 303 were mixed so as to satisfy the relation of first powder+second powder:third powder=90 wt %:10 wt % as described above. More specifically, the powders were mixed so as to satisfy the relation of first powder 301:second powder 302:third powder 303=36 wt %: 54 wt %: 10 wt %.

Since the fine powder may inhibit the flow of powder during press molding, and the packing density of the powder may not be increased, the weight ratio of third powder 303 which is the finest in the soft magnetic powders is preferably not more than 50 wt % of the whole crushed powder. Further, the weight ratio of third powder 303 is preferably equal to or lower than 30 wt % of the whole crushed powder. Further, the weight ratio of third powder 303 is preferably equal to or lower than 20 wt % of the whole crushed powder.

In contrast, the total weight ratio of first powder 301 and second powder 302 is preferably equal to or higher than 50 wt % of the whole crushed powder. In order to increase the packing density of the soft magnetic powder, the proportion of second powder 302 having a small particle diameter is preferably set to be larger than that of first powder 301 having a large particle diameter. In other words, when mixing first powder 301, second powder 302, and third powder 303, the amount of second powder 302 is preferably set to be larger than that of first powder 301.

As described above, in Example 1, there were a certain number of particles of first powder 301 having a particle diameter equal to or larger than 32 μm, and certain numbers of particles of second powder 302 and third powder 303 having a particle diameter equal to or smaller than 32 μm as illustrated in FIG. 3.

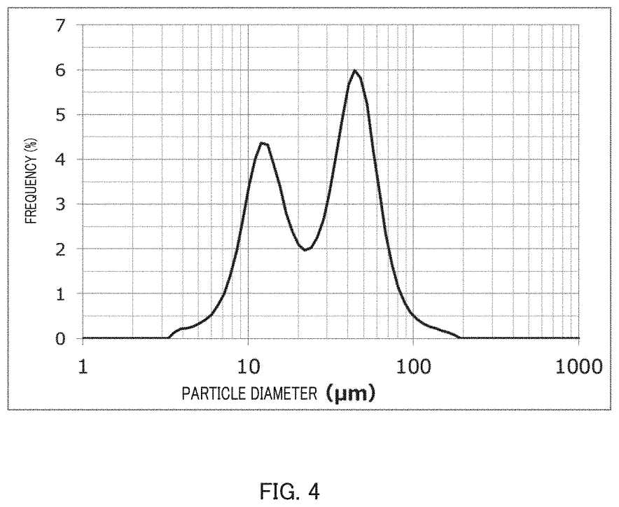

A particle size distribution of the soft magnetic powder of Example 1 is illustrated in FIG. 4. The particle size distribution illustrated in FIG. 4 was measured by Microtrac MT 3000 series II. In FIG. 4, the horizontal axis represents the particle diameter, and the vertical axis represents the frequency at which particles of the soft magnetic powder having the respective particle diameters are present. In a cumulative distribution, D10% was about 9 μm, D50% was about 29 μm, and D 90% was about 59 μm.

<Particle Diameter Details>

The particle diameters of first powder 301, second powder 302, and third powder 303 are as described above, and the respective particle diameters will be described in more detail below.

In this example, the average particle diameter of first powder 301 having a particle diameter equal to or larger than 32 μm was about 47 μm. The average particle diameter of second powder 302 having a particle diameter equal to or smaller than 32 μm was about 16 μm. The average particle diameter of third powder 303 having a particle diameter equal to or smaller than 32 μm was about 8 μm. As used herein the term average particle diameter is a numerical value for D50% of a cumulative particle size distribution measured by Microtrac MT 3000 series II.

In order to increase the packing density of the soft magnetic powder, it is preferable that the relationship among the respective average particle diameters of first powder 301, second powder 302, and third powder 303 satisfies the relationship of the average particle diameter of first powder 301>the average particle diameter of second powder 302>the average particle diameter of third powder 303.

In addition, if there are too much difference in average particle diameters among first powder 301, second powder 302 and third powder 303, fine third powder 303 may inhibit the flow of the powder during press molding, and the packing density of the powder may not be increased.

Therefore, the average particle diameter of first powder 301 preferably falls within the range from 30 μm to 60 μm. Further, the average particle diameter of first powder 301 preferably falls within the range from 40 μm to 50 μm.

The average particle diameter of second powder 302 preferably falls within the range from 10 μm to 20 μm.

The average particle diameter of third powder 303 preferably falls within the range from 4 μm to 12 μm.

<Dust Core>

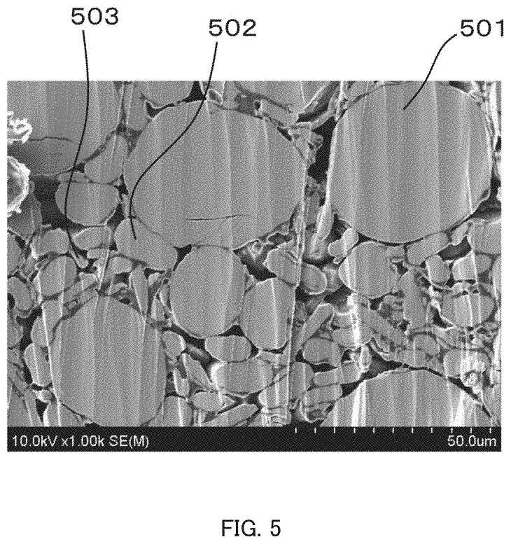

FIG. 5 illustrates an SEM image of a cross section of a dust core made of the soft magnetic powder of Example 1.

Cross section 501 is a cross section of first powder 301 (powder 104 illustrated in FIG. 1C). Cross section 502 is a cross section of second powder 302 (powder 105 illustrated in FIG. 1C). Cross section 503 is a cross section of third powder 303 (powder 106 illustrated in FIG. 1C).

Since first powder 301 has a spherical shape as described above, cross section 501 of first powder 301 is circular as illustrated in FIG. 5. Further, since second powder 302 has an ellipsoidal shape as described above, cross section 502 of second powder 302 has an elliptical shape as illustrated in FIG. 5. Further, since third powder 303 is scaly as described above, cross section 503 of third powder 303 has a scale shape as illustrated in FIG. 5.

Further, by using cyclone mill 200, the powder of the soft magnetic composition is retained and the powder particles are made collide with each other, whereby the temperature of the surfaces of the powder particles is increased and an Fe oxide film is formed on the surfaces of the powder particles. When crushing is performed at an oxygen concentration of 0.1% (N2 purge), the thickness of the Fe oxide film was equal to or smaller than 20 nm. The thickness of the Fe oxide film is preferably equal to or smaller than 20 nm, and more preferably equal to or smaller than 10 nm.

Since the crushing method of cyclone mill 200 is a method of making the powder particles collide with each other, the thickness of the Fe oxide film on the surfaces of the powder particles can be made smaller than the crushing method in which the powder particles are made collide with blades, a ball, or the like. Further, by performing crushing in a low oxygen concentration, the thickness of the Fe oxide film can be reduced so that the soft magnetic properties of the dust core can be improved.

<Surface Smoothness>

The surface smoothness of each of first powder 301, second powder 302, and third powder 303 will be described below.

The surface smoothness is a value obtained by dividing actual surface area S1 of a particle (powder particle) by surface area S2 of a spherical particle having a perfect smooth surface, the spherical particle having a volume equivalent diameter D equivalent to the particle (powder particle) and having a surface roughness Ra of 0. The closer the surface smoothness is to 1, the smoother the surface of the particle.

Surface area S1 can be measured, for example, by a specific surface area meter of a gas adsorption type. Surface area S2 can be obtained by calculating a surface area of a sphere having a diameter equivalent to a volume equivalent diameter D.

In this example, the surface smoothness of first powder 301 was 1.616, the surface smoothness of second powder 302 was 2.138, and the surface smoothness of third powder 303 was 4.268.

Since the frictional resistance among particles is reduced by reducing the surface smoothness, desirable fluidity can be obtained. In particular, when the dust core is manufactured, a thermosetting resin (an example of a binder) mixed with the soft magnetic powder can be prevented from entering into fine irregularities on the surfaces of the particles of the soft magnetic powder and being incapable of contributing to the flow, and press molding is achieved with a smaller amount of thermosetting resin. Therefore, a high packing density of the soft magnetic powder is achieved. Therefore, the proportion of soft magnetic powder per unit volume is increased, and soft magnetic properties such as saturation magnetic flux density and magnetic permeability of the dust core can be improved.

An effect of increasing the packing density of the soft magnetic powder by reducing the surface smoothness can be sufficiently obtained as long as the surface smoothness is equal to or higher than 1.1. It should be noted that the production of particles having a surface smoothness of lower than 1.1 is costly.

Therefore, the surface smoothness of first powder 301 preferably falls within the range from 1.1 to 2.0. The surface smoothness of second powder 302 preferably falls within the range from 1.7 to 2.5. The surface smoothness of third powder 303 is equal to or higher than 3.4.

<Flatness>

The flatness of first powder 301, second powder 302, and third powder 303 will be described.

The flatness is a value obtained by dividing the largest half axis by the smallest half axis out of the three half axes of the ellipsoid. The closer the flatness is to 1.0, the closer the shape is to the sphere.

In Example 1, first powder 301 includes large number of particles having a flatness within the range from 1.0 to 1.2. Second powder 302 includes a large number of particles having a flatness within the range from 3.0 to 6.0. Third powder 303 includes a large number of particles having a flatness exceeding 6.0.

During press molding, the powder having a flatness equal to or larger than 1.2 is disposed with the longitudinal direction thereof extends along the flow direction of the powder. Therefore, since the projected area of the powder having a flatness equal to or larger than 1.2 as viewed from the flow direction is smaller than the projected area of the substantially spherical powder having a flatness less than 1.2, the flow resistance can be reduced. In other words, the pressure during press molding can be reduced.

Therefore, when manufacturing a dust core formed by mixing soft magnetic particles with a thermosetting resin (an example of a binder), it is also possible to mold a mixture having a higher viscosity with less amount of resin and less amount of solvent, so that the packing density of the soft magnetic powder can be increased.

In the case of second powder 302 and third powder 303 having a surface smoothness larger than that of first powder 301, the fluidity of the binder can be improved by increasing the degree of flatness thereof. Therefore, particles of second powder 302 can enter into gaps among particles of first powder 301 with a small amount of binder. In addition, particles of third powder 303 can enter into gaps among particles of second powder 302 with a small amount of binder.

It should be noted that the flatness has a greater impact than the surface smoothness because of the above-described effects. The reason is that the flatness has a greater impact on an outer shape than the surface smoothness. Further, when the crushing time is increased, the flatness of the particles does not significantly change, but as the surface is scraped off little by little due to the collision among the powder particles, the surface smoothness gradually degrades. In addition, when a dust core is produced, the flatness is more important than the surface smoothness in order to obtain a desirable fluidity of the binder.

Accordingly, the proportion of soft magnetic powder per unit volume is increased, and soft magnetic properties such as saturation magnetic flux density and magnetic permeability of the dust core can be improved.

### Advantageous Effect

According to the friction crushing used in Embodiment 1 and Example 1, the particle size distribution of spherical first powder 301 having a particle diameter larger than 32 μm, ellipsoidal second powder 302 having a particle diameter equal to or smaller than 32 μm, and scaly third powder 303 having a particle diameter equal to or smaller than 32 μm can be easily controlled.

In Embodiment 1 and Example 1, a dust core is produced, and the dust core includes spherical first powder 301 having a surface smoothness within the range from 1.1 to 2.0 and a flatness within the range from 1.0 to 1.2, ellipsoidal second powder 302 having a surface smoothness within the range from 1.7 to 2.5 and a flatness within the range from 3.0 to 6.0, and scaly third powder 303 having a surface smoothness equal to or larger than 3.4 and having a flatness equal to or larger than 6.0.

In this way, during the production of the dust core, desirable fluidity is obtained with a small amount of binder, which allows second powder 302 to enter gaps among particles of first powder 301 and allows third powder 303 to enter into gaps among particles of second powder 302. Therefore, a high packing density of the soft magnetic powder is achieved. Therefore, the proportion of soft magnetic powder per unit volume is increased, and soft magnetic properties such as saturation magnetic flux density and magnetic permeability of the dust core can be improved.

Furthermore, the soft magnetic powder of Embodiment 1 has a spherical shape or an ellipsoidal shape, and does not have an angled part such as an edge. Therefore, the powder is not in electrical continuity among the powder particles by biting into the adjacent powder particles, so that the voltage-resistant performance can be improved. In addition, in some cases, the scaly powder may have an angled part, but since the particle diameter is small, the powder does not dig into adjacent powders to cause electric field concentration, so that the voltage-resistant performance is not degraded.

Accordingly, in Embodiment 1 and Example 1, highly dense filling of the soft magnetic powder can be achieved while ensuring insulation among the particles of the soft magnetic powder. Therefore, a dust core achieving both the high magnetic permeability and the high voltage resistance is provided.

### Embodiment 2

Embodiment 2 of the present disclosure will be described below.

<Characteristic of Dust Core According to Embodiment 2>

A dust core according to Embodiment 2 contains a powder of a soft magnetic composition which is a mixture of a spherical crushed powder having a flatness within the range from 1.0 to 1.2 and an ellipsoidal crushed powder having a flatness within the range from 3.0 to 6.0.

Alternatively, the dust core according to Embodiment 2 contains a powder of a soft magnetic composition which is a mixture of spherical crushed powder having a surface smoothness within the range from 1.1 to 2.0 and a flatness within the range from 1.0 to 1.2 and an ellipsoidal crushed powder having a surface smoothness within the range from 1.7 to 2.5, and a flatness within the range from 3.0 to 6.0.

It should be noted that the soft magnetic composition is not particularly limited as long as it exhibits soft magnetic properties, such as a metal, an alloy, a silicon steel sheet, an amorphous alloy, and a nanocrystalline alloy.

In addition, the powder of the soft magnetic composition needs only to contain at least the spherical crushed powder and the ellipsoidal crushed powder, and may also contain components which do not correspond to these powders in a part of the powder. The physical properties and the manufacturing method of the powder of the soft magnetic composition will be described below, and then the dust core and the method of manufacturing the same will be described.

<Surface Smoothness of Powder of Soft Magnetic Composition>

As described above, the powder of the soft magnetic composition includes at least the spherical crushed powder and the ellipsoidal crushed powder. Among them, the surface smoothness of the spherical crushed powder falls within the range from 1.1 to 2.0, and preferably from 1.1 to 1.7. On the other hand, the surface smoothness of the ellipsoidal crushed powder falls within the range from 1.7 to 2.5, and preferably from 1.7 and 2.2.

The surface smoothness is a value obtained by dividing the actual surface area S1 of the particles by the surface area S2 of the spherical particles of perfectly smooth surface having the same volume equivalent diameter D as that of the particles and having a surface roughness of 0, and the surface smoothness is more smooth as the surface smoothness is closer to 1. The surface area S1 of the actual particles can be measured, for example, by a ratio specific surface area meter of a gas adsorption type. Surface area S2 of the spherical particles can be obtained by calculating a surface area of a sphere having a diameter equivalent to a volume equivalent diameter D.

By reducing the surface smoothness of the spherical crushed powder and of the ellipsoidal crushed powder contained in the powder of the soft magnetic composition, frictional resistance among particles when the dust core is produced is reduced, and desirable fluidity is obtained. In particular, when the dust core is formed by mixing the powder of the soft magnetic composition with a binder (for example, a thermosetting resin), the amount of the resin entering into fine irregularities on the surfaces of the crushed powder particles and being incapable of contributing to the flow is reduced. Therefore, press molding is achieved with a smaller amount of the binder (thermosetting resin). Consequently, a high packing density of the powder of the soft magnetic composition in the dust core is achieved. Therefore, the proportion of powder of the soft magnetic composition per unit volume is increased, and soft magnetic properties such as saturation magnetic flux density and magnetic permeability of the dust core can be improved.

It should be noted that an effect of increasing the packing density by reducing the surface smoothness can be sufficiently obtained as long as the surface smoothness of the spherical crushed powder is equal to or lower than 2.0. On the other hand, particles having an excessively smooth surface with a surface smoothness of lower than 1.1 are not preferable in terms of manufacturing cost and the like. In addition, in the case of an ellipsoidal crushed powder, if the surface smoothness is equal to or lower than 2.5, the above described effects can be sufficiently obtained.

<Flatness of Powder of Soft Magnetic Composition>

Furthermore, the flatness of the spherical crushed powder contained in the powder of the soft magnetic composition falls within the range from 1.0 to 1.2, and is preferably from 1.0 to 1.1. On the other hand, the flatness of the ellipsoidal crushed powder falls within the range from 3.0 to 6.0, and preferably from 3.0 to 4.0.

The flatness is a value obtained by dividing the largest half axis by the smallest half axis out of the three half axes of the powder of the soft magnetic composition (especially ellipsoidal powder), and the closer the flatness is to 1.0, the closer the flatness is to 1.0, the closer the shape is to the sphere.

As will be described later, when the dust core is manufactured, granulated powder containing the powder of the soft magnetic composition is subjected to press molding. At this time, the ellipsoidal crushed powder having a flatness equal to or higher than 1.2 (preferably, a flatness equal to or higher than 3.0) is easily oriented along the flow direction of the powder than the roughly spherical crushed powder having a flatness of lower than 1.2. When the crushed powder is oriented in this manner, the projected area when observed from the upstream side is smaller than that of the spherical shape. Therefore, the flow resistance is reduced. In other words, by containing a certain amount of the ellipsoidal crushed powder together with the spherical crushed powder, the pressure during press molding can be reduced. Consequently, the amount of resin and the amount of solvent can be reduced, and even if the viscosity is high, molding can be performed. Therefore, a high packing density of the powder of the soft magnetic composition in the dust core is achieved.

It should be noted that the flatness has a greater impact than the surface smoothness because of the above-described effects. The reason is that the flatness has a greater impact on an outer shape than the surface smoothness.

Further, when the crushing time is increased, the flatness of the particles does not significantly change, but as the surface is scraped off little by little due to the collision among the powder particles, the surface smoothness gradually degrades. In addition, when a dust core is produced, the flatness is more important than the surface smoothness in order to obtain a desirable fluidity of the binder.

Further, by increasing the flatness of the ellipsoidal crushed powder having a large flat surface smoothness (that is, having a relatively low surface smoothness), a desirable fluidity of the binder can be easily obtained. Then, the ellipsoidal crushed fine powder can enter gaps among large particles of spherical crushed powder by a small amount the binder. Therefore, the proportion of powder of the soft magnetic composition per unit volume is increased, and soft magnetic properties such as saturation magnetic flux density and magnetic permeability of the dust core can be improved.

<Particle Diameter of Powder of Soft Magnetic Composition>

The average particle diameter of the spherical crushed powder contained in the powder of the soft magnetic composition preferably falls within the range from 30 μm to 60 μm, and more preferably from 30 μm to 50 μm. On the other hand, the average particle diameter of the ellipsoidal crushed powder preferably falls within the range from 10 μm to 20 μm. The average particle diameters described above are respectively numerical values for D50% of a cumulative particle size distribution measured by Microtrac MT 3000 series II.

Here, the proportion of the powder having particle diameters larger than 32 μm, which is contained in the powder of the soft magnetic composition, is preferably equal to or lower than 50 wt %, and more preferably equal to or lower than 45 wt %. In contrast, the proportion of the powder having particle diameters equal to or smaller than 32 μm is preferably equal to or higher than 50 wt %, and more preferably equal to or higher than 55 wt % or more. Whether or not the particle diameter of the powder is equal to or smaller than 32 μm can be determined depending on whether or not the particles can pass through an opening of 32 μm.

When the powder of the soft magnetic composition is produced by using a cyclone mill as described later, the average particle diameter of the spherical crushed powder is likely to increase, and the average particle diameter of the ellipsoidal crushed powder is likely to become small. Therefore, the proportion of the spherical crushed powder contained in the powder of the soft magnetic composition preferably equal to or lower than 50 wt %, and the proportion of the ellipsoidal crushed powder is preferably equal to or higher than 50 wt %. It is more preferable that the proportion of the ellipsoidal crushed powder is larger.

<Method of Manufacturing Powder of Soft Magnetic Composition>

A method of manufacturing the powder of the soft magnetic composition having the above-described physical properties will be described. The powder of the soft magnetic composition can be produced by Step 1 of making ribbons or flakes of a soft magnetic composition, Step 2 of crushing the ribbons or the flakes by a cyclone mill, and Step 3 of heat-treating the crushed powder.

More specifically, in Step 1, the alloy composition (soft magnetic composition) is melted by high-frequency heating or the like to produce ribbons or flakes composed of an amorphous layer by a liquid quenching method. A single-roll amorphous manufacturing apparatus used for manufacturing Fe-based amorphous ribbons and a twin-roll amorphous manufacturing apparatus can be used in the liquid quenching method.

In Step 2, the ribbons or the flakes obtained in Step 1 are crushed into a powder. The crushing of the ribbons or the flakes is effected by causing friction among the ribbons and/or the flakes with each other to achieve friction crushing by using the cyclone mill. As in the prior art, when the ribbons or the flakes heated and crystallized, ribbons or the flakes become brittle and thus are easily crushed. In this case, however, the hardness of the ribbons or the flakes becomes high, and thus crushing finely becomes difficult. That is, the proportion of the crushed powder having a small particle diameter is reduced. Therefore, in Embodiment 2, the ribbons or the flakes are crushed without being heated. Accordingly, the ribbons or the flakes having low hardness can be sufficiently crushed, and the proportion of the crushed powder having a small particle diameters can be increased. The powder obtained by crushing may be classified by means of a sieve. Accordingly, the particle size distribution of the powder of the soft magnetic composition can fall within a desired range.

In Step 3, the crushed powder of the ribbons or the flakes is heat-treated to remove internal strain caused by crushing or to precipitate an αFe crystal layer. As the heat treatment apparatus, for example, a hot air oven, a hot press, a lamp, a sheathed metallic heater, a ceramic heater, a rotary kiln, or the like can be used. It should be noted that the heating temperature is not particularly limited as long as the internal strain can be removed or the αFe crystal layer can be precipitated.

<Detailed Description of Step 2>

A manufacturing mechanism of the crushed powder in the Step 2 will now be described with reference to FIGS. 1A to 1C. When the cyclone mill is used, soft magnetic ribbons (or may be the soft magnetic flake) 101 such as the one illustrated in FIG. 1A are entrained in the airflow and rub up against each other. Accordingly, as illustrated in FIG. 1B, the surface of soft magnetic ribbon 101 is scraped off, and powder 102 having a large particle diameter and powder 103 having a small particle diameter are produced.

Further, by continuing the crushing, powder 102 having a large particle diameter and powder 103 having a small particle diameter are also entrained in the airflow, and the powders rub up against each other. Accordingly, as illustrated in FIG. 1C, the surfaces of the powders of powder 102 having a large particle diameter are scraped off, and spherical powder 104 as described above is produced. Further, the surfaces of the particles of powder 103 having a small particle diameter are scraped off to generate an ellipsoidal powder 105. In addition to spherical powder 104 and ellipsoidal powder 105, a scaly powder 106, which is a scraped material obtained by shaving the surfaces of soft magnetic ribbons 101 is also produced.

Next, a crushing mechanism using a cyclone mill will be described with reference to FIG. 2.

The cyclone mill is an apparatus including a plurality of (two, in this case) rotary blades having a plurality of blades. On raw material inlet port 202 side of crushing chamber 201 of the cyclone mill, an airflow directed radially outward generated by one rotary blade 203 and an airflow drawn by the other rotary blade 204 are generated. Further, on outlet port 205 side of crushing chamber 201 to which the suction apparatus is connected, an airflow directed radially outward and an airflow drawn by the suction apparatus toward outlet port 205 side are generated by rotary blade 204. That is, in crushing chamber 201 of the cyclone mill, a circulating flow is constantly generated around rotary blades 203 and rotary blades 204.

When raw material 206 is charged from raw material inlet port 202, raw material 206 is entrained in the circulating flow generated by rotary blade 203 on raw material inlet port 202 side, and moves to crushing chamber 201. A part of the raw material moved to crushing chamber 201 (raw material particles 207 subjected to an action of a suction force of the suction apparatus) is recovered through outlet port 205.

On the other hand, the raw material to be subjected to the circulating flow of rotary blade 204 on outlet port 205 side is entrained in the circulating flow and is moved to the center side of crushing chamber 201 again. An airflow directed radially outward is generated on the center side of crushing chamber 201 by rotary blade 203 provided on raw material inlet port 202 side. Accordingly, the raw material being acted upon by the airflow generated by rotary blade 203 and the raw material being acted upon by the airflow generated by rotation blade 204 rub up against each other. Accordingly, friction crushing of the raw material is performed. The crushed powder is moved toward the outside of crushing chamber 201 by an action of the airflow generated by rotary blade 204 on outlet port 205 side. Then, the crushed powder is recovered from outlet port 205 under an action of the suction apparatus. This operation is repeated to crush the raw material.

The crushing time for the raw material is not limited, and is selected as appropriate depending on the degree of crushing. In the examples described later, the crushing time is set to 50 minutes. However, by adjusting the crushing time, a required shape and particle diameter can be obtained. By making ribbons 101 of the soft magnetic composition entrained in the circulating flow generated by the two rotary blades, the surfaces of ribbons 101 of the soft magnetic composition can be scraped off, and finally, spherical powder 104 and ellipsoidal powder 105 can be produced. In this process, large particles are guided to the outer periphery of the crushing chamber by a centrifugal force. On the other hand, the fine powder converges toward the axis of rotation (central portion) of the rotary blades, and is sucked toward outlet port 205. Therefore, only the fine powder having a certain particle diameter is continuously discharged from outlet port 205.

It should be noted that the large particles are entrained in the circulating flow generated by the two rotary blades and remain in the crushing chamber, while the surfaces of the large particles are scraped off. Meanwhile, the scraped shavings are sucked and discharged through outlet port 205. Therefore, powder 104 of rounded spherical particles and powder 105 of rounded ellipsoidal particles are produced in crushing chamber 201.

In the example described later, a cyclone mill 150S, which is of a single-motor type manufactured by Shizuoka Plant Co., Ltd., was used as cyclone mill 200. The rotational speed is preferably 11,000 to 15,000 rpm, and the optimum value is 15,000 rpm. Therefore, in Example 2 described later, a rotational speed of 15,000 rpm was used.

In the case of using a planetary ball mill, an attritor, a sample mill, or a vibration mill, the spherical powder or the ellipsoidal powder cannot be produced (that is, the particles cannot be rounded), and the average particle diameter of the powder exceeds 20 μm. When a mixer mill is used, the average particle diameter of the powder is 10's μm, but the spherical powder or the ellipsoidal powder cannot be produced (that is, the particles cannot be rounded). In addition, the crushing cannot be achieved by the jet mill.

<Dust Core>

The dust core only needs to contain at least the powder of the soft magnetic composition described above, and may also contain a binder and other components as needed. The shape and size of the dust core are selected as appropriate according to the application thereof. The shape and size of the general dust core may be the same as those of the general dust core.

<Method of Manufacturing Dust Core>

Next, a method of manufacturing a dust core made of the powder of the soft magnetic composition described above will be described. The dust core can be produced, for example, by performing Step 4 of mixing the powder of the soft magnetic composition produced in Steps 1 to 3 with a binder to produce granulated powder, Step 5 of press molding, and Step 6 of heating and curing the binder.

Specifically, in Step 4, the powder of the soft magnetic composition obtained as described above is mixed with a binder having desirable insulation properties and high heat-resistance such as a phenol resin and a silicone resin to produce a granulated powder. The amount of the binder used in producing the granulated powder is preferably 1 to 8 parts by mass, and more preferably 1 to 3 parts by mass, based on 100 parts by mass of the powder of the soft magnetic composition.

In Step 5, a mold having a desired shape and having a high heat-resistance is filled with the granulated powder produced in Step 4, and is subjected to press molding to obtain a green compact. The pressure to be applied during press molding and the duration of press molding is selected as appropriate depending on the amount of the binder, the required strength of the dust core, and the like. The press molding can be performed by using a general press apparatus.

After Step 5, a dust core having a low loss in the high-frequency region is obtained by heating at a temperature at which the binder is cured as needed in Step 6. The temperature at this time is selected as appropriate depending on the type of the binder.

### Example 2

Example 2 in which the method of manufacturing a soft magnetic powder and the method of manufacturing a dust core according to Embodiment 2 of the present invention described above will be described in detail below.

Fe based amorphous alloy ribbons of Fe73.5-Cu1-Nb3-Si13.5-B9 (numerical values after the element symbol represent atomic %) produced by a rapid-cooling single-roll method were crushed by using a cyclone mill for 50 minutes to obtain a powder of the soft magnetic composition composed of amorphous layers. The powder of the soft magnetic composition was heat-treated to remove internal strain caused by crushing, and an αFe crystal layer was precipitated. The heat treatment was performed by a hot press at 560° C. for 2 seconds.

Further, a silicone resin was mixed as a binder with the powder of the soft magnetic composition and granulated to produce a granulated powder. Next, the granulated powder was charged into a mold and press-molded by using a press machine at a molding pressure of 4 ton/cm², and then the binder was cured so that a dust core was produced. The silicone resin is set to about 3 parts by mass based on 100 parts by mass of the powder of the soft magnetic composition.

<Evaluation of Core Loss>

The core loss of the obtained dust core at a frequency of 100 kHz and a magnetic flux density of 25 mT was measured with a B-H analyzer. The acceptance criteria of core loss was set to 110 kW/m³ at the maximum. It is aimed that the core loss does not exceed that of a general metallic material. The core loss measured by the B-H analyzer was 58 kW/m³, which passed the acceptance criteria. In other words, a dust core having a low loss in the high-frequency region was obtained.

<Evaluation of Shape of Powder Particle>

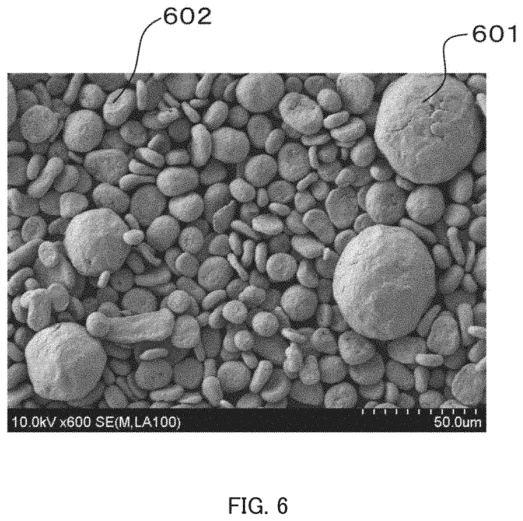

FIG. 6 illustrates an SEM image of the powder of the soft magnetic composition obtained in Example 2 (powder prior to production of the dust core). Powder 601 having a large particle diameter is the spherical crushed powder described above (corresponding to powder 104 in FIG. 1C described above), and powder 602 is the ellipsoidal crushed powder described above (corresponding to powder 105 in FIG. 1C described above). By the crushing mechanism described above, powder 601 having a relatively large particle diameter is formed into a spherical shape, and powder 602 having a small particle diameter is formed into an ellipsoidal shape.

The particle diameter of the powder of the soft magnetic composition obtained was evaluated. Consequently, the proportion of particles (powder) having a particle diameter larger than 32 μm was 40 wt % of the whole crushed powder. The proportion of particles (powder) having a particle diameter equal to or smaller than 32 μm was 60 wt % of the whole crushed powder. It should be noted that the particle diameter was determined by whether the particle can pass through an opening having a diameter of 32 μm.

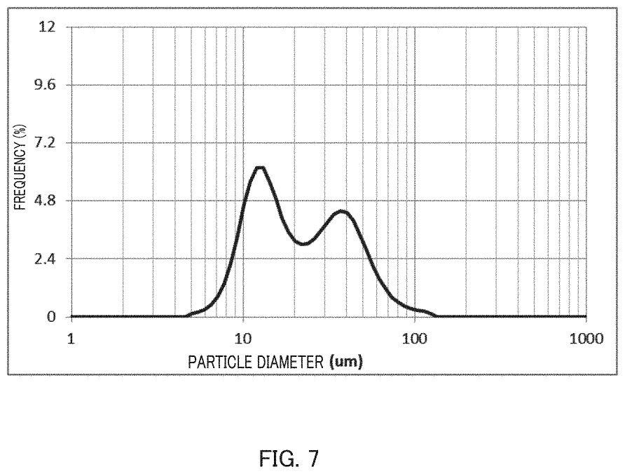

Next, FIG. 7 illustrates the particle size distribution of the powder of the soft magnetic composition in Example 2. The particle size distribution was measured by the Microtrac MT 3000 series II. In FIG. 7, the horizontal axis represents the particle diameter and the vertical axis represents the frequency at which powder particles having each particle diameter are present in the powder of the soft magnetic composition. As illustrated in FIG. 7, a certain number of powder particles having a particle diameter larger than 32 μm were present. In contrast, the particle size distribution showed that a large amount of powder particles having a particle diameter equal to or smaller than 32 μm were present. It should be noted that the flatness of the powder having a particle diameter larger than 32 μm is mainly within the range from 1.0 to 1.2 and the flatness of the powder having a particle diameter smaller than 32 μm is mainly within the range from 3.0 to 6.0. The average particle diameter of the powder having a particle diameter larger than 32 μm was 47.3 μm, and the average particle diameter of the powder having a particle diameter equal to or smaller than 32 μm was 16.2 μm. As used herein the term average particle diameter means a numerical value of D50% of the cumulative particle size distributions obtained by measuring the particle size distribution for a powder having a particle diameter larger than 32 μm and for a powder having a particle diameter equal to or smaller than 32 μm by the Microtrac MT 3000 series II. When the particle size distribution of the entire powder of the soft magnetic composition was measured, D10% of the cumulative particle size distribution was about 9 μm, D50% was about 19 μm, and D90% was about 49 μm.

The surface smoothness of the powder having a particle diameter larger than 32 μm was 1.616, and the surface smoothness of the powder having a particle diameter equal to or smaller than 32 μm was 2.138. In other words, it is apparent that the powder of the soft magnetic composition includes a spherical crushed powder having a surface smoothness within the range from 1.1 to 2.0 and a flatness within the range from 1.0 to 1.2, and an ellipsoidal crushed powder having a surface smoothness within the range from 1.7 to 2.5 and a flatness within the range from 3.0 to 6.0.

<Cross Section of Dust Core>

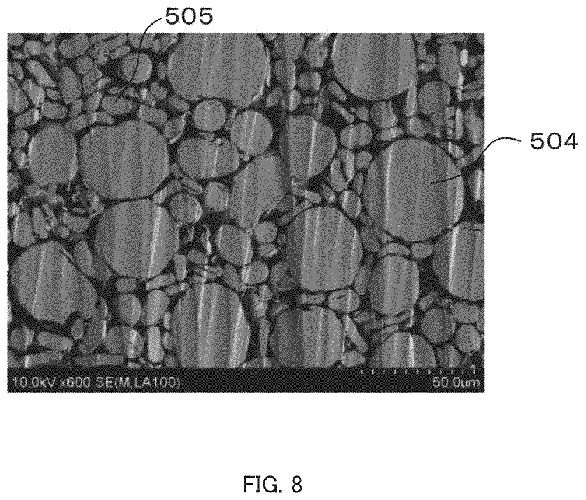

FIG. 8 illustrates an SEM image of a cross section of a dust core made of the powder of the soft magnetic composition in Example 2. Cross section 504 is a cross section of the spherical powder described above (corresponding to powder 104 in FIG. 1C described above). Cross section 505 is a cross section of the ellipsoidal powder described above (corresponding to powder 105 in FIG. 1C described above). In this manner, it is apparent that the dust core of Example 2 contains a spherical powder and an ellipsoidal powder.

Further, by using cyclone mill 200, the powder of the soft magnetic composition is retained and the powder particles are made collide with each other, whereby the temperature of the surfaces of the powder particles is increased and an Fe oxide film is formed on the surfaces of the powder particles. When crushing is performed at an oxygen concentration of 0.1% (N2 purge), the thickness of the Fe oxide film was equal to or smaller than 20 nm. The thickness of the Fe oxide film is preferably equal to or smaller than 20 nm, and more preferably equal to or smaller than 10 nm.

Since the crushing method of cyclone mill 200 is a method of making the powder particles collide with each other, the thickness of the Fe oxide film on the surfaces of the powder particles can be made smaller than the crushing method in which the powder particles are made collide with blades, a ball, or the like. Further, by performing crushing in a low oxygen concentration, the thickness of the Fe oxide film can be reduced so that the soft magnetic properties of the dust core can be improved.

### Advantageous Effects

According to the friction crushing using a cyclone mill, the particle size distribution of the powder of the soft magnetic composition can be easily controlled so that large amounts of the crushed powder having a spherical shaped particles having a particle diameter of larger than 32 μm and the crushed powder particles having an ellipsoidal shape having a particle diameter equal to or smaller than 32 μm are present.

Therefore, when a dust core is produced using the soft magnetic composition, desirable fluidity can be obtained with a small amount of binder. For example, ellipsoidal powder particles having a particle diameter equal to or smaller than 32 μm may enter gaps among the spherical crushed powder particles having a particle diameter larger than 32 μm. Therefore, the packing density of the powder of the soft magnetic composition in the dust core can be increased. Therefore, the proportion of powder of the soft magnetic composition per unit volume is increased, and soft magnetic properties such as saturation magnetic flux density and magnetic permeability of the dust core can be improved.

Further, since the amount of the crushed powder having a particle diameter equal to or larger than 32 μm is equal to or smaller than 50 wt % of the whole crushed powder and amount of the crushed powder having a particle diameter equal to or smaller than 32 μm is equal to or larger than 50 wt % of the whole crushed powder, the electric resistance of the crushed powder is increased. In particular, eddy currents can be reduced even in a high-frequency (for example, equal to or larger than 100 kHz) region, and eddy current loss can be reduced. Therefore, the loss of the dust core made of the crushed powder described above may be reduced.

Furthermore, the powder of the soft magnetic composition is a mixture of the powder of spherical particles and the powder of ellipsoidal particles, and these powder particles have no angled part such as an edge. Therefore, the powder particles are not in electrical continuity with each other by biting into the adjacent powder particles, so that the voltage-resistant performance can be improved.

However, in the crushed powder obtained by the technique of Patent Literature 1, the proportion of crushed powder 1 having a particle diameter equal to or larger than two times the thickness of the ribbons (particle diameter: 50 μm) is large. Therefore, the electric resistance of crushed powder 1 itself is small. Further, when the frequency is high (for example, equal to or higher than 100 kHz), eddy current increases, and eddy current loss increases abruptly. Therefore, the loss of the dust core using the crushed powder in Patent Literature 1 was likely to increase.

As described above, according to Embodiment 2 and Example 2, the eddy current loss of the powder of the soft magnetic composition can be reduced even in the high-frequency region, and in addition, a dust core capable of obtaining a high saturation magnetic flux density and excellent soft magnetic properties is achieved.

### Embodiment 3

Embodiment 3 of the present disclosure will be described below.

<Characteristics of Dust Core according to Embodiment 3>

A dust core according to Embodiment 3 contains a powder of a soft magnetic composition which is a mixture of an ellipsoidal crushed powder having a flatness within the range from 3.0 to 6.0.

Alternatively, a dust core according to Embodiment 3 contains a powder of a soft magnetic composition which is a mixture of an ellipsoidal crushed powder having a surface smoothness within the range from 1.7 to 2.5 and a flatness within the range from 3.0 to 6.0.

It should be noted that the soft magnetic composition needs only to exhibit soft magnetic properties, such as a metal, an alloy, a silicon steel sheet, an amorphous alloy, and a nanocrystalline alloy. In addition, the powder of the soft magnetic composition needs only to contain at least the ellipsoidal crushed powder, and may also contain components (for example, scaly crushed powder) which do not correspond to these powders in a part of the powder.

<Surface Smoothness of Powder of Soft Magnetic Composition>

As described above, the powder of the soft magnetic composition includes at least the ellipsoidal crushed powder. The surface smoothness of the ellipsoidal crushed powder falls within the range from 1.7 to 2.5, and preferably from 1.7 and 2.2. In the case where the powder of the soft magnetic composition contains a scaly crushed powder, the surface smoothness of the scaly crushed powder is preferably equal to or higher than 3.4.

The surface smoothness is a value obtained by dividing actual surface area S1 of a particle by surface area S2 of a spherical particle having a perfect smooth surface, The spherical particle having a volume equivalent diameter D which is the same the particle and having a surface roughness of 0. The closer the surface smoothness is to 1, the smoother the surface of the particle. The surface area S1 of the actual particles can be measured, for example, by a proportion specific surface area meter of a gas adsorption type. Surface area S2 of the spherical particles can be obtained by calculating a surface area of a sphere having a diameter equivalent to a volume equivalent diameter D.

By reducing the surface smoothness of the ellipsoidal crushed powder contained in the powder of the soft magnetic composition, frictional resistance among the particles when the dust core is produced is reduced, and desirable fluidity is obtained. In particular, when the dust core is formed by mixing the powder of the soft magnetic composition with a binder (for example, a thermosetting resin), the amount of the resin entering into fine irregularities on the surfaces of the crushed powder particles and being incapable of contributing to the flow is reduced. Therefore, press molding is achieved with a smaller amount of the binder. Consequently, a high packing density of the powder of the soft magnetic composition in the dust core is achieved. Therefore, the proportion of powder of the soft magnetic composition per unit volume is increased, and soft magnetic properties such as saturation magnetic flux density and magnetic permeability of the dust core can be improved.

It should be noted that an effect of increasing the packing density by reducing the surface smoothness can be sufficiently obtained as long as the surface smoothness of the ellipsoidal crushed powder is equal to or lower than 2.5.

<Flatness of Powder of Soft Magnetic Composition>

The flatness of the ellipsoidal crushed powder contained in the powder of the soft magnetic composition falls within the range from 3.0 to 6.0, and preferably from 3.0 to 4.0. Further, a scaly crushed powder may be contained. The scaly crushed powder preferably contains particles having a flatness larger than 6.0 as main components.

As used herein the term flatness is a value obtained by dividing the largest half axis (long half axis) by the smallest half axis (short half axis) out of the three half axes of the powder of the soft magnetic composition (especially ellipsoidal crushed powder). The closer the flatness is to 1.0, the closer the shape is to the sphere.

As will be described later, when the dust core is manufactured, granulated powder containing the powder of the soft magnetic composition is subjected to press molding. In this case, the ellipsoidal crushed powder having a flatness of equal to or larger than 1.2 is easily oriented along the flow direction of the powder. When the crushed powder is oriented in this manner, the projected area when observed from the upstream side is smaller than that of the spherical shape. Therefore, the flow resistance is reduced. In other words, by containing a certain amount of the ellipsoidal crushed powder in the whole crushed powder, the pressure during press molding can be reduced. Accordingly, the amount of resin and the amount of solvent can be reduced, and even if the viscosity is high, molding can be performed. Therefore, a high packing density of the powder of the soft magnetic composition in the dust core is achieved.

Further, by increasing the flatness of the ellipsoidal crushed powder having a large flat surface smoothness (that is, having a relatively low surface smoothness), a desirable fluidity of the binder can be easily obtained. Therefore, the proportion of powder of the soft magnetic composition per unit volume is increased, and soft magnetic properties such as saturation magnetic flux density and magnetic permeability of the dust core can be improved.

<Particle Diameter of Powder of Soft Magnetic Composition>

The average particle diameter of the ellipsoidal crushed powder contained in the powder of the soft magnetic composition preferably falls within the range from 10 μm to 20 μm. The average particle diameter of the scaly crushed powder preferably falls within the range from 4 μm to 12 μm. The average particle diameters described above are respectively numerical values for D50% of a cumulative particle size distribution measured by Microtrac MT 3000 series II.

The average particle diameter of the ellipsoidal crushed powder and the scaly crushed powder contained in the powder of the soft magnetic composition preferably equal to or smaller than 32 μm. Whether or not the particle diameter of the powder is equal to or smaller than 32 μm can be determined depending on whether or not the particles can pass through openings of 32 μm of the sieve or the like.

<Method of Manufacturing Soft Magnetic Powder>

A method of manufacturing a soft magnetic powder according to Embodiment 3 of this disclosure will be described.

First, an alloy composition is melted by high-frequency heating or the like and then is cooled by a liquid quenching method to produce ribbons or flakes of an amorphous layer (Step 1).

When performing the liquid quenching method, for example, a single-roll amorphous manufacturing apparatus or a twin-roll amorphous manufacturing apparatus used for manufacturing Fe-based amorphous ribbons may be used.

Although a case where the ribbon(s) of an amorphous layer (hereinafter simply referred to as “ribbon(s)”) are produced will be described below as an example, it is needless to say that the following description will apply to a case where flakes are produced.

Next, the ribbons obtained in Step 1 are crushed to obtain a crushed powder (Step 2).

As a method of crushing the ribbons, for example, a method of causing the ribbons to rub up against each other by using a cyclone mill is exemplified. Details of this method will be described later with reference to FIG. 2.

In general, it is known that when the ribbons are heated and crystallized before crushing, the ribbons become brittle and are easy to be crushed. On the other hand, when heated, the ribbons are increased in hardness and thus become difficult to be crushed. Accordingly, the proportion of the crushed powder having a small particle diameter to the whole crushed powder is reduced.

Therefore, in Embodiment 3, a method of crushing the ribbons without being heated is employed in Step 2. Accordingly, the hardness of the ribbons is reduced, and thus the ribbons can be crushed finely. Accordingly, the proportion of the crushed powder having a small particle diameter can be increased in the whole crushed powder.

It should be noted that the crushed powder obtained in Step 2 is classified by using, for example, a sieve or a classifier. Accordingly, a crushed powder having a desired particle size distribution can be obtained.

For example, a sieve having openings of 32 μm may be used to obtain a crushed powder having a particle diameter of equal to or smaller than 32 μm from the crushed powder particles obtained in Step 2. For example, a classifier of an airflow type may be used to obtain a crushed powder having a particle diameter of equal to or smaller than 32 μm from the crushed powder particles obtained in Step 2.

Next, the crushed powder obtained in Step 2 is heat-treated to remove internal strain caused by crushing or to precipitate an αFe crystal layer (Step 3).

As the heat treatment apparatus used in Step 3, for example, a hot air oven, a hot press, a lamp, a sheathed heater, a ceramic heater, or a rotary kiln can be used.

It should be noted that the temperature for heating the crushed powder in Step 3 is not particularly limited as long as the internal strain can be removed or the αFe crystal layer can be precipitated.

By Step 1 to 3 described above, a crushed powder made from amorphous layer ribbons, that is, a soft magnetic powder can be produced.

<Manufacturing Mechanism of Crushed Powder>

A manufacturing mechanism of the crushed powder in Step 2 will now be described with reference to FIG. 1A to FIG. 1C.

Examples of soft magnetic ribbon 101 (an example of the soft magnetic composition) illustrated in FIG. 1A include a metal, an alloy, a silicon steel sheet, an amorphous alloy, or a nanocrystalline alloy, which have a soft magnetic property.

When the cyclone mill is used, soft magnetic ribbons 101 such as the one illustrated in FIG. 1A are entrained in the airflow and rub up against each other. Accordingly, as illustrated in FIG. 1B, the surface of soft magnetic ribbon 101 is scraped off, and powder 102 having a large particle diameter and powders 103 having a small particle diameter are produced.

Further, by continuing the crushing, powder 102 and powder 103 are also entrained in the airflow, and particles of the powder 102 and 103 rub up against each other. Accordingly, surfaces of particles of powder 102 are scraped off, and spherical powder 104 and scaly powder 106 as illustrated in FIG. 1C are produced. Moreover, the surfaces of particles of powder 103 are scraped off and powder 105 of ellipsoidal particles and powder 106 of scaly particles are produced as illustrated in FIG. 1C. Powder 106 is shavings scraped from powder 102 or powder 103.

The manufacturing mechanism of the crushed powder has been described above.

<Crushing Mechanism by Cyclone Mill>

The crushing mechanism by the cyclone mill will be described with reference to FIG. 2. FIG. 2 schematically illustrates an example of a configuration of cyclone mill 200 used in Embodiment 3.

Cyclone mill 200 includes crushing chamber 201, raw material inlet port 202, rotary blades 203 and 204, outlet port 205, rotary shaft 208, and drive source 209.

Raw material inlet port 202 is an opening through which raw material 206 is charged, and communicates with crushing chamber 201. Raw material 206 is, for example, soft magnetic ribbons 101 illustrated in FIG. 1A.

Outlet port 205 is in communication with crushing chamber 201, and is an opening through which raw material particles 207 generated in crushing chamber 201 are discharged. A suction apparatus (not illustrated) is provided outside outlet port 205.

Crushing chamber 201 is a space in which raw material 206 is crushed.

Crushing chamber 201 is provided with rotary blades 203 and 204. Rotary blades 203 and 204 are fixed to rotary shaft 208, respectively. Rotary shaft 208 is rotated by drive source 209 (for example, a motor), as indicated by arrow a. Accordingly, rotary blades 203 and 204 are rotated in the same manner.

As rotary blades 203 and 204 are rotated, airflow 210 and circulating flows 211 and 212 are constantly generated.

Airflow 210 is an airflow flowing from an inlet side of crushing chamber 201 through crushing chamber 201 to an outlet side of crushing chamber 201.

Circulating flow 211 is an airflow that circulates along a surface of rotary blade 203.

Circulating flow 212 is an airflow that circulates along a surface of rotary blade 204.

A flow of charging raw material 206 to cyclone mill 200 having such a configuration as described above to obtain various powders illustrated in FIG. 1C will be described below.

Raw material 206 charged from raw material inlet port 202 are entrained in airflow 210 and flows into crushing chamber 201.

Part of raw material 206 that has flowed into crushing chamber 201 is entrained in circulating flow 211 or circulating flow 212 and moves in crushing chamber 201. At this time, raw material 206 entrained in circulating flow 211 and raw material 206 entrained in circulating flow 212 rub up against each other and thus are crushed. Accordingly, the surfaces of the raw materials 206 are scraped off, and powders 104, 105 and 106 illustrated in FIG. 1C are produced.

Powder 106 (raw material particles 207 illustrated in FIG. 2), which is a fine powder, converges toward an axis (center portion of rotary blades 203 and 204) of rotary shaft 208, is entrained in airflow 210, flows out of crushing chamber 201, and is discharged from outlet port 205 by a suction force of the suction apparatus (not illustrated). In this manner, only powder 106 having a constant particle diameter can be continuously recovered. The recovered powder 106 is, for example, scaly.

In contrast, powders 104 and 105, which are larger than powder 106, are entrained in circulating flow 211 or circulating flow 212, and are retained in crushing chamber 201 while the surfaces being scraped off. It should be noted that powder 106 is also produced from powders 104 and 105 during the retention. Powder 106 was also discharged from outlet port 205 as described above.

When the crushing was completed, powder 104 of rounded spherical particles and powder 105 of rounded ellipsoidal particles are left in crushing chamber 201.

Next, powders 104 and 105 remaining in crushing chamber 201 are classified by a sieve or the like to obtain only powder 105. It should be noted that powder 106 recovered from outlet port 205 may be mixed with powder 105 obtained here.

The execution time of crushing in cyclone mill 200 is selected as appropriate according to the desired shape and particle diameter. In the examples described later, the execution time of crushing was 20 minutes.

In the example described later, cyclone mill 150BMS, which is of a single-motor type manufactured by Shizuoka Plant Co., Ltd., was used as cyclone mill 200. In cyclone mill 200, the rotational speed is preferably 11,000 to 15,000 rpm, and the optimum value is 15,000 rpm. Therefore, in an example described later, a rotational speed of 15,000 rpm was used.

In the case of using a planetary ball mill, an attritor, a sample mill, or a vibration mill, particles of the ribbons cannot be rounded, and thus ellipsoidal powder cannot be created. In addition, the average particle diameter of the powder to be formed is greater than 20 μm. When a mixer mill is used, the average particle diameter of the powder is 10 μm to 20 μm, but the particles of the ribbons cannot be rounded and thus ellipsoidal crushed powder cannot be created. In addition, crushing cannot be achieved by the jet mill.

<Method of Manufacturing Dust Core>

The dust core of Embodiment 3 may be produced only of ellipsoidal powder 105 among the soft magnetic powders described above, or may be produced by mixing the binder or other components (for example, scaly crushed powder 106) with ellipsoidal powder 105. The shape and size of the dust core according to Embodiment 3 are selected as appropriate according to the application thereof. Therefore, the dust core according to Embodiment 3 may have the same shape and size as those of a general dust core.

A method of manufacturing the dust core according to the embodiments of this disclosure will be described below.

First, the soft magnetic powder produced in Step 1 to 3 is mixed with a binder to produce granulated powder (Step 4).

Examples of the binder include a resin having good insulation properties and high heat-resistance (for example, a phenol resin or a silicone resin).

The amount of the binder used in producing the granulated powder is preferably 1 to 8 parts by mass, and more preferably 1 to 3 parts by mass, based on 100 parts by mass of the soft magnetic powder.

Next, a mold having a high heat-resistance and having a desired shape is filled with the granulated powder obtained in Step 4, and is subjected to press molding to obtain a green compact (Step 5).

The pressure during press molding and the duration of execution of the press molding are selected as appropriate depending on the amount of the binder, the required strength of the dust core, and the like. The press molding can be performed by using a general press apparatus.

Next, the green compact obtained in Step 5 is heated at a temperature at which the binder is cured (Step 6).

The heating temperature is selected as appropriate depending on the type of the binder.

By the Step 4 to 6 described above, a dust core having a high magnetic permeability with less loss in the high-frequency region can be produced.

### Example 3

Example 3 in which the method of manufacturing the soft magnetic powder and the method of manufacturing the dust core according to Embodiment 3 described above will be described in detail below.

In Example 3, Fe based amorphous alloy ribbons of Fe73.5-Cu1-Nb3-Si13.5-B9 (numerical values after the element symbol represent atomic %) produced by a rapid-cooling single-roll method were crushed by using a cyclone mill for 20 minutes to obtain a soft magnetic powder composed of amorphous layers. Further, the soft magnetic powder obtained was classified, and the soft magnetic powder having a particle diameter equal to or smaller than 32 μm was removed as an object to be treated.

Next, the soft magnetic powder was heat-treated to remove internal strain caused by crushing, and an αFe crystal layer was precipitated. The heat treatment was performed at 570° C. for 10 seconds by using a hot press.

Next, the heat-treated soft magnetic powder was granulated by mixing a silicone resin as a binder, thereby producing a granulated powder. The silicone resin is set to about 3 parts by mass based on 100 parts by mass of the soft magnetic powder.

Next, the granulated powder was charged into a mold, and press-molded by using a press machine at a molding pressure of 4 ton/cm² to cure the binder, so that a dust core was produced.

<Evaluation of Voltage Resistance>

The voltage resistance of the dust core obtained as described above was measured. The voltage resistance is a voltage in which a current flowing when a voltage is applied from above and below the dust core exceeds a certain amount. The measured voltage resistance was improved by about 20% compared to the soft magnetic powder containing spherical powder 104 and ellipsoidal powder 105 as comparative targets. In other words, a dust core having a high voltage resistance could be obtained.

<Shape of Soft Magnetic Powder>

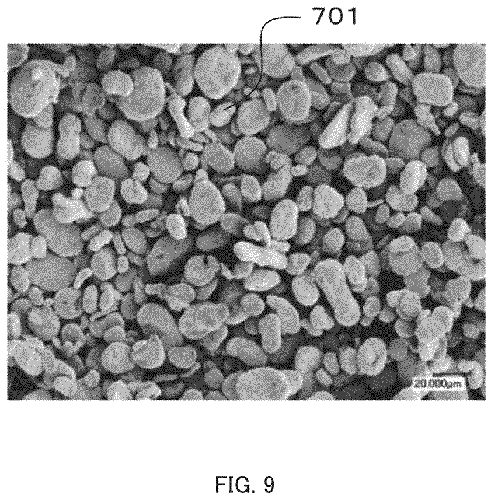

The shape of the soft magnetic powder (powder prior to production the dust core) obtained in Example 3 will be described with reference to FIG. 9. FIG. 9 illustrates an SEM (Scanning Electron Microscope) image of the soft magnetic powder according to Example 3.

In FIG. 9, powder 701 corresponds to powder 105 illustrated in FIG. 1C. By the crushing mechanism and classification described above, powder 701 illustrated in FIG. 9 is an ellipsoidal powder having a particle diameter equal to or smaller than 32 μm.

<Particle Size Distribution of Soft Magnetic Powder>

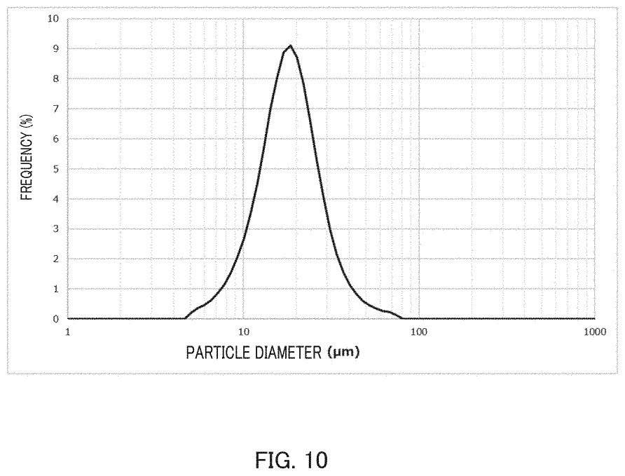

A particle size distribution of the soft magnetic powder of Example 3 is illustrated in FIG. 10. The particle size distribution illustrated in FIG. 10 was measured by Microtrac MT 3000 series II. In FIG. 10, the horizontal axis represents the particle diameter, and the vertical axis represents the frequency at which particles of the soft magnetic powder having each particle diameter are present.

As illustrated in FIG. 10, the average particle diameter of the soft magnetic powder was 17.4 μm. As used herein the term average particle diameter is a numerical value for D50% of a cumulative particle size distribution when measuring the particle size distribution of the powder by Microtrac MT 3000 series II.

The surface smoothness of the soft magnetic powder having a particle diameter equal to or smaller than 32 μm was 2.138. In other words, it is apparent that the soft magnetic powder having a particle diameter equal to or smaller than 32 μm includes ellipsoidal powder 105 having a surface smoothness within the range from 1.7 to 2.5 and a flatness within the range from 3.0 to 6.0.

In the case where the execution time of crushing by cyclone mill 200 is made longer than 20 minutes, the flatness of ellipsoidal powder 105 does not greatly change. However, as the surfaces of the particles are scraped little by little due to the collision among the particles, so that the surface smoothness of ellipsoidal powder 105 is lowered. In addition, when a dust core is produced, the flatness is more important than the surface smoothness in order to obtain a desirable fluidity of the binder.

<Cross Section of Dust Core>

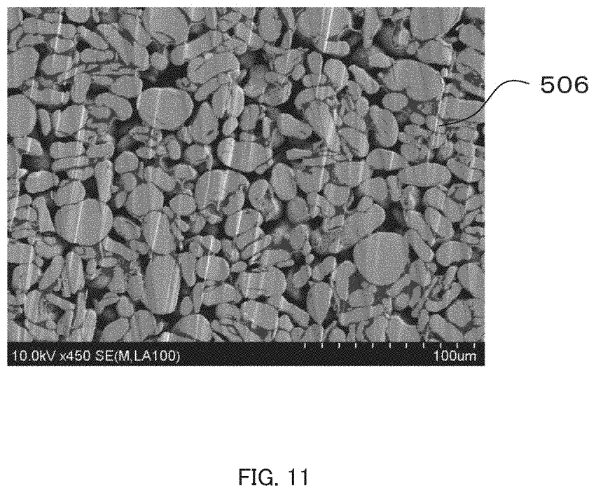

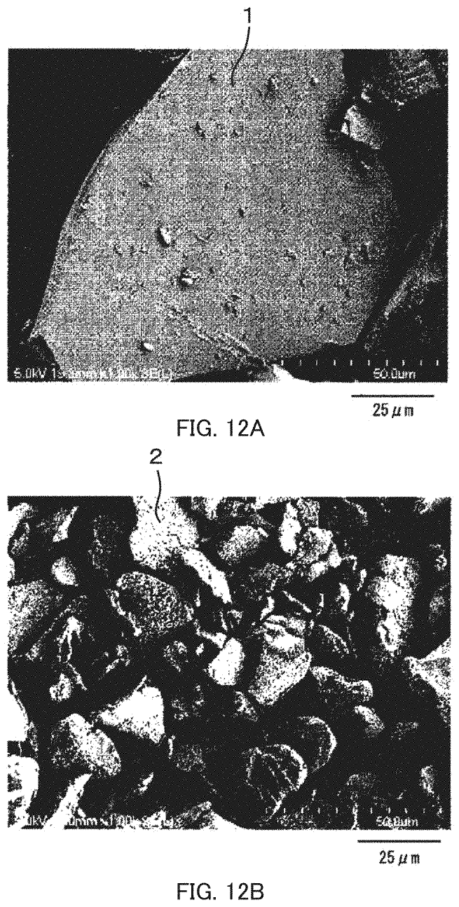

FIG. 11 illustrates an SEM image of a cross section of a dust core made of the soft magnetic powder of Example 3.

Cross section 506 illustrated in FIG. 11 is a cross section of powder 105 illustrated in FIG. 1C.

Further, by using cyclone mill 200, the powder of the soft magnetic composition is retained and the powder particles are made collide with each other, whereby the temperature of the surfaces of the powder particles is increased and an Fe oxide film is formed on the surfaces of the powder particles. When crushing is performed at an oxygen concentration of 0.1% (N2 purge), the thickness of the Fe oxide film was equal to or smaller than 20 nm. The thickness of the Fe oxide film needs only be at least equal to or larger than 3 nm.

Since the crushing method of cyclone mill 200 is a method of making the powder particles collide with each other, the thickness of the Fe oxide film on the surfaces of the powder particles can be made smaller than the crushing method in which the powder particles are made collide with blades, a ball, or the like. Further, by performing crushing in a low oxygen concentration, the thickness of the Fe oxide film can be reduced so that the soft magnetic properties of the dust core can be improved.

### Advantageous Effects

According to the friction crushing using cyclone mill 200 in Embodiment 3 and Example 3, the particle size distribution of the soft magnetic powder can be easily controlled so that only ellipsoidal powder 105 having a particle diameter equal to or smaller than 32 μm is present or that ellipsoidal powder 105 having a particle diameter equal to or smaller than 32 μm and the scaly powder 106 having a particle diameter equal to or smaller than 32 μm are present.

Accordingly, during the production of the dust core, desirable fluidity can be obtained with a small amount of binder, so that scaly powder 106 can enter gaps among the particles of ellipsoidal powder 105. Therefore, a high packing density of the soft magnetic powder in the dust core is achieved. Therefore, the proportion of soft magnetic powder per unit volume is increased, and soft magnetic properties such as saturation magnetic flux density and magnetic permeability of the dust core can be improved.

Furthermore, the ellipsoidal powder 105 of Embodiment 3 has no angled part such as an edge. Therefore, the powder is not in electrical continuity among the powder particles by particles of powder 105 biting into the adjacent powder particles, so that the voltage-resistant performance can be improved. In addition, scaly powder 106 may have an angled part, but has a small particle diameter. Therefore, particles of powder 106 do not bite into the adjacent powder particles, so that electric field concentration does not occur, so that the voltage-resistant performance is not degraded. In addition, since ellipsoidal powder 105 and scaly powder 106 have a small particle size and a high internal resistance, electric charges during the application of voltage are dispersed, so that the voltage-resistant performance can be improved.

Accordingly, in Embodiment 3 and Example 3, highly dense filling of the soft magnetic powder can be achieved while ensuring insulation among the particles of the soft magnetic powder. Therefore, a dust core achieving both the high magnetic permeability and the high voltage resistance is provided.

The present disclosure is not limited to the description of the embodiments described above, and various modifications may be made without departing from the spirit and scope of the present invention. Further, these embodiments may be combined as appropriate.

### INDUSTRIAL APPLICABILITY

The dust core and the method of manufacturing the same of the present disclosure are useful for a dust core employing a soft magnetic powder, which is used in inductors such as choke coils, reactors, and transformers.

### REFERENCE SIGNS LIST

1,2 crushed powder
101 soft magnetic ribbon
102, 103, 104, 105, 106, 601, 602, 701 powder
201 crushing chamber
202 raw material inlet port
203, 204 rotary blade
205 outlet port
206 raw material
207 raw material particles
501, 502, 503, 504, 505, 506 cross section
301 first powder
302 second powder
303 third powder

1. A dust core, comprising a powder of a soft magnetic composition, wherein the powder of the soft magnetic composition contains an ellipsoidal powder having at least a flatness within a range from 3.0 to 6.0 both inclusive.

2. The dust core according to claim 1, wherein a surface smoothness of the ellipsoidal powder falls within a range from 1.7 to 2.5 both inclusive.

3. The dust core according to claim 1, wherein the powder of the soft magnetic composition further comprises a scaly powder having a flatness larger than 6.0.

4. The dust core according to claim 3, wherein a surface smoothness of the scaly powder is equal to or higher than 3.4.

5. The dust core according to claim 3, wherein an average particle diameter of the scaly powder falls within a range from 4 μm to 12 μm both inclusive.

6. The dust core according to claim 1, wherein an average particle diameter of the ellipsoidal powder falls within a range from 10 μm to 20 μm both inclusive.

7. The dust core according to claim 1, wherein the powder of the soft magnetic composition contains only a powder having a particle diameter equal to or smaller than 32 μm.

8. The dust core according to claim 1, wherein an Fe oxide film having a thickness equal to or smaller than 20 nm is formed on a surface of a particle of the ellipsoidal powder.

9. The dust core according to claim 1, wherein the powder of the soft magnetic composition further includes a spherical powder having a flatness within a range from 1.0 to 1.2 both inclusive and a scaly powder having a flatness larger than 6.0.

10. The dust core according to claim 9, wherein a surface smoothness of a spherical powder falls within a range from 1.1 to 2.0 both inclusive, and a surface smoothness of the scaly powder is equal to or larger than 3.4.

11. The dust core according to claim 9, wherein an average particle diameter of the spherical powder falls within a range from 30 μm to 60 μm both inclusive.

12. The dust core according to claim 9, wherein an average particle diameter of the ellipsoidal powder falls within a range from 10 μm to 20 μm both inclusive.

13. The dust core according to claim 9, wherein an average particle diameter of the scaly powder falls within a range from 4 μm to 12 μm both inclusive.

14. The dust core according to claim 9, wherein a weight ratio of the scaly powder is equal to or lower than 50 wt % of a whole powder.

15. The dust core according to claim 9, wherein a total weight ratio of the spherical powder and the ellipsoidal powder is equal to or higher than 50 wt % of a whole powder.

16. The dust core according to claim 9, wherein the amount of the ellipsoidal powder is larger than the amount of the spherical powder.

17. The dust core according to claim 9, wherein an Fe oxide film having a thickness smaller than 20 nm is formed on surfaces of particles of the spherical powder, the ellipsoidal powder and the scaly powder.

18. The dust core according to claim 1, wherein the powder of the soft magnetic composition further comprises a spherical powder having a flatness within a range from 1.0 to 1.2 both inclusive.

19. The dust core according to claim 18, wherein a surface smoothness of the spherical powder falls within a range from 1.1 to 2.0 both inclusive.

20. The dust core according to claim 18, wherein an average particle diameter of the spherical powder falls within a range from 30 μm to 60 μm both inclusive.

21. The dust core according to claim 18, wherein an average particle diameter of the ellipsoidal powder falls within a range from 10 μm to 20 μm both inclusive.

22. The dust core according to claim 18, wherein a proportion of the powder having a particle diameter larger than 32 μm contained in a powder of the soft magnetic composition is equal to or lower than 50 wt %.

23. The dust core according to claim 18, wherein a proportion of the powder having a particle diameter equal to or smaller than 32 μm contained in the powder of the soft magnetic composition is equal to or larger than 50 wt %.

24. The dust core according to claim 18, wherein an Fe oxide film having a thickness equal to or smaller than 20 nm is formed on surfaces of particles of the spherical powder and the ellipsoidal powder.

25. A method of manufacturing a dust core, the method comprising:
producing at least an ellipsoidal powder by causing particles of soft magnetic composition to rub up against each other;
mixing the ellipsoidal powder with a binder to produce a granulated powder;
filling a predetermined mold with the granulated powder and performing press-molding to obtain a green compact; and
heating the green compact at a temperature at which the binder is cured, wherein the flatness of the ellipsoidal powder falls within a range from 3.0 to 6.0 both inclusive.

26. The method of manufacturing a dust core, according to claim 25, wherein
the producing further includes producing a spherical powder,
the mixing further includes mixing the spherical powder with the binder to produce the granulated powder, and
a flatness of the spherical powder falls within a range from 1.0 to 1.2 both inclusive.

27. The method of manufacturing a dust core, according to claim 25, wherein
the producing further includes producing a scaly powder,
the mixing further includes mixing the scaly powder with the binder to produce the granulated powder, and
a flatness of the scaly powder is equal to or larger than 6.0.

28. The method of manufacturing a dust core, according to claim 26, wherein
the producing further includes producing a scaly powder,
the mixing further includes mixing the scaly powder with the binder to produce the granulated powder, and
a flatness of the scaly powder is equal to or larger than 6.0.
